(19) United States
(12) Patent Application Publication
(10) Pub. No.: US 2026/0277744 A1
(43) Pub. Date: Sep. 17, 2026

(54) INFORMATION HANDLING SYSTEM WITH A DYNAMIC BOOT MANIFEST POLICY FOR BOOT FAILURE RECOVERY

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Amit K. Tiwari, Austin, TX (US); Marcin Nowak, Prosper, TX (US)

(21) Appl. No.: 19/077,969

(22) Filed: Mar. 12, 2025

(51) Int. Cl. G06F 11/14

(52) U.S. Cl. CPC G06F 11/1417; G06F 2201/805

(57) ABSTRACT

An information handling system includes a system on a chip (SoC) that executes normal boot operations in the information handling system, and provides boot markers associated with the normal boot operations. The system also includes an embedded controller that monitors the normal boot operations being executed by the SoC and stores the boot markers received from the SoC. Based on the boot markers, the system determines whether a boot failure has occurred. In response to the boot failure, the system generates a boot manifest policy that removes failed components of the normal boot operations from new boot operations.

### FIELD OF THE DISCLOSURE

The present disclosure generally relates to information handling systems, and more particularly relates to an information handling system with a dynamic boot manifest policy for boot failure recovery.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a system on a chip (SoC) that may execute normal boot operations in the information handling system and provide boot markers associated with the normal boot operations. The system also includes an embedded controller that may monitor the normal boot operations being executed by the SoC and store the boot markers received from the SoC. Based on the boot markers, the system may determine whether a boot failure has occurred. In response to the boot failure, the system may generate a boot manifest policy that removes failed components of the normal boot operations from new boot operations.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of an information handling system according to at least one embodiment of the present disclosure;

FIG. 2 is a flow diagram of a method for recovering from a boot failure with a dynamic boot manifest policy according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

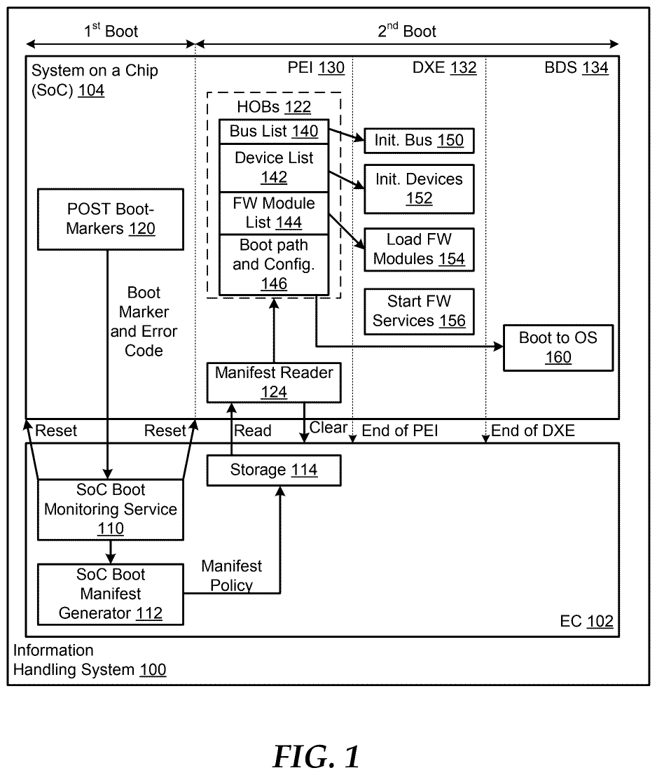

FIG. 1 illustrates a portion of an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes an embedded controller 102 and a system on a chip (SoC) 104. Embedded controller 102 includes a SoC boot monitoring service 110, a SoC boot manifest generator 112, and a storage 114. SoC 104 includes power-on self-test (POST) boot markers 120, hand off blocks (HOBs) 122, and a manifest reader 124. Information handling system 100 may include additional components without varying from the scope of this disclosure.

During operation of information handling system 100, embedded controller 102 may release SoC 104 from a reset state. After releasing SoC 104, embedded controller 102 may monitor normal power-on system test (POST) boot operations of SoC 104. In an example, a service basic input/output system (SBIOS) of SOC 104 may start the POST boot operations through any suitable stages or phases. For example, the SBIOS may initialize the chipset, the core, the memory, the hardware buses, hardware devices, and other firmware modules. In certain examples, these operations of the SBIOS may be performed as per an available user custom boot policy, a default boot policy, or the like that may be required to boot the configured OS of SoC 104 from a secondary storage media.

In certain examples, the BIOS image for SoC 104 may be designed with boot markers 120 for every critical stage of the POST flow or process. These critical stages of the POST may be any stages of the POST, such as security (SEC), pre-extensible firmware interface (pre-PEI), driver execution environment (DXE), and boot device selection (BDS). In response to a boot marker stage during the POST being performed, the BIOS of SoC 104 may provide the corresponding boot marker 120 to embedded controller 102 over any available communication as per the SOC design. For example, the SBIOS of SoC 104 may synchronize with embedded controller 102 by sending the boot markers via any suitable transfer process such as over a mailbox (MBOX), a defined port, or the like. In an example, SBIOS of SoC 104 may communicate error codes to embedded controller 102 based on detection of known warnings, error states, or the like.

In certain examples, SoC boot monitoring service 110 of embedded controller 102 may keep track of the boot maker and the error code received from the SBIOS of SoC 104. In an example, the reception of the last boot marker and the error code may identify a failed state of the POST boot operations in SoC 104. In this example, the failed state of the boot operations may include an indication of one or more failed components of SoC 104. Embedded controller 102 may perform any suitable operations to determine whether the received boot marker 120 is the last boot marker. For example, embedded controller 102 may determine that boot marker 120 is the last boot marker based on the boot marker being sent with an error code. In an example, the embedded controller 102 may determine that boot marker 120 is the last boot marker based on a particular length of time expiring before the next boot marker is received.

For example, embedded controller 102 may keep track of SoC 104 POST process through the received boot markers 120. While monitoring the POST via SoC monitoring service 110, embedded controller 102 may determine whether each subsequent boot marker 120 is received before a timeout event has occurred. In response to the next boot marker 120 being received before the timeout event, embedded controller 102 may determine whether a boot marker 120 is the last boot marker for the POST process. In an example, embedded controller 102 may determine whether the received boot marker is the last boot marker based on a stored boot marker table. In certain examples, the boot marker table may be created during the build time of the BIOS and embedded controller 102 of information handling system 100.

Embedded controller 102 may continuously perform a SoC boot monitoring loop which includes, but is not limited to, receiving a boot marker 120, storing the boot marker, determining whether the timeout event has occurred, and determining whether the boot marker is the last boot marker. In an example, embedded controller 102 may exit the SoC boot monitoring loop if either the last boot marker is received, the timeout event occurred before the next boot marker 120 is received, an error code is received with the boot marker, or the like.

In response to receiving the boot marker and the error code, SoC boot monitoring service 110 may determine that a boot failure has occurred in SoC 104. In an example, the boot failure may cause a no post-no video (NP-NV) state of information handling system 100. In response to the boot failure, SoC boot manifest generator 112 of embedded controller 102 may dynamically generate a boot manifest policy, which may be utilized during a subsequent boot operation to recovery information handling system 100 from the NP-NV state. In an example, SoC boot manifest generator 112 may create or generate the boot manifest policy based on any suitable data collected during the normal boot operations. For example, embedded controller 102 may utilize the received last boot marker and error code to create the boot manifest policy. In certain examples, the boot manifest policy may identify one or more components to remove from the boot operations of SoC 104. These components may include, but are not limited to, buses, devices, and firmware modules of the information handling system. SoC boot manifest generator 112 may store the boot manifest policy in storage 114.

After storing the boot manifest policy in storage 114, embedded controller 102 may reset SoC 104 and cause the SoC to boot in a safe boot mode. In an example, the boot manifest policy may ensure that SoC 104 is booted in a safe boot mode by removing the failed buses, devices, firmware modules, or the like via an alternative secure boot path. In certain examples, SoC boot manifest generator 112 may determine the components, such as buses, devices, firmware modules, or the like, to remove from the boot operations based on the boot marker 120 and error code received from SoC 104.

In an example, the safe boot mode may ensure that SoC 104 may boot to a good known state for a user to initiate the rest of the recovery from a no post-no video (NP-NV) state. In response to the boot manifest policy being stored in storage 114, the boot manifest policy may be published to SoC 104 in any suitable manner. For example, the boot manifest policy may be published via a memory-mapped input/output (MMIO) read only mode configured between embedded controller 102 and SoC 104.

After the boot manifest policy is published, embedded controller 102 may reboot SoC 104 in a safe boot mode. This safe boot mode may include booting only essential system components. On reboot, SoC 104 may read the boot manifest policy from storage 114 of embedded controller 102 over MMIO. In response to reading the boot manifest policy, SoC 104 may provide a clear policy request to embedded controller 102. Based on the clear policy request, embedded controller 102 may delete the boot manifest policy from storage 114. In an example, SoC 104 may utilize the boot manifest policy instead of any available custom/default boot policy to bring information handling system 100 to a known state.

Based on the boot manifest policy, SoC 104 may create multiple HOBs 122 during PEI phase 130 of the safe boot mode. In an example, HOBs 122 may be data structures used in the Unified Extensible Firmware Interface (UEFI) boot process to transfer information from one phase of the boot sequence to the next. In this example, HOBs 122 may pass critical system state details between different stages of initialization, like from PEI phase 130 to DXE phase 132. HOBs 122 may allow each phase to access necessary information to smoothly continue the boot process.

In an example, HOBs 122 may include a bus list 140, a device list 142, a firmware module list 144, and a boot path and configuration 146. The SBIOS of SoC 104 may create bus list 140, device list 142, firmware module list 144, and boot path and configuration 146 based on the boot manifest policy received from embedded controller 102. During PEI phase 130, the SBIOS of Soc 104 may filter out failed hardware, firmware, software, and configuration components from HOBs 122 based on data in boot manifest policy. The removal of these components from the boot manifest policy and the subsequent boot operation may enable information handling system 100 to boot into a safe mode.

In response to bus list 140, device list 142, firmware module list 144, and boot path and configuration 146 being created during PEI phase 130 of the safe boot, HOBs 122 may pass the boot operations to DXE phase 132. During DXE phase 132, SBIOS of SoC 104 may initialize buses 150, devices 152, and firmware modules 154 based on the bus list 140, device list 142, firmware module list 144, and boot path and configuration 146. The SBIOS of SoC 104 may also start or begin firmware services 156 during DXE phase 132. In response to the completed of DXE phase 132, SoC 104 may boot to operating system (OS) 160 during BDS phase 134. Thus, SoC 104 may utilize the boot manifest policy to remove components that failed during a previous boot operation, such that information handling system 100 may recover from a no post/no video (NP-NV) state and boot to a safe mode.

In an example, embedded controller 102 may monitor the boot operations of SoC 104 during the safe boot mode. In this example, the boot manifest policy may include the boot markers at different phases of the boot operations, such that SoC boot monitoring service 110 may receive the boot markers from SoC 104 during the safe boot operations. Embedded controller 102 may continuously perform a SoC boot monitoring loop which includes, but is not limited to, receiving boot markers 120, storing the boot markers, determining whether the timeout event has occurred, and determining whether a boot marker is the last boot marker. In an example, embedded controller 102 may exit the SoC boot monitoring loop if either the last boot marker is received, the timeout event occurred before the next boot marker 120 is received, an error code is received with the boot marker, or the like.

In response to receiving the boot marker and the error code, SoC boot manifest generator 112 of embedded controller 102 may dynamically generate a new or updated boot manifest policy. In an example, SoC boot manifest generator 112 may create or generate the new or updated boot manifest policy based on any suitable data collected during the safe boot operations created from the utilization of the first boot manifest policy. For example, embedded controller 102 may utilize the received last boot marker and error code to create the new or updated boot manifest policy. In certain examples, the new or updated boot manifest policy may identify one or more additional components to remove from the boot operations of SoC 104.

After the new or updated boot manifest policy is published, via storage 114, embedded controller 102 may reset SoC 104 to cause a new safe boot mode to be performed by the SoC. In response to the reset, the SBIOS of SoC 104 may perform boot operations based on the new or updated boot manifest policy which may cause the SBIOS to remove components that failed during the previous boot operation. The new or updated boot manifest policy may enable information handling system 100 may recover from the NP-NV state and boot to known state.

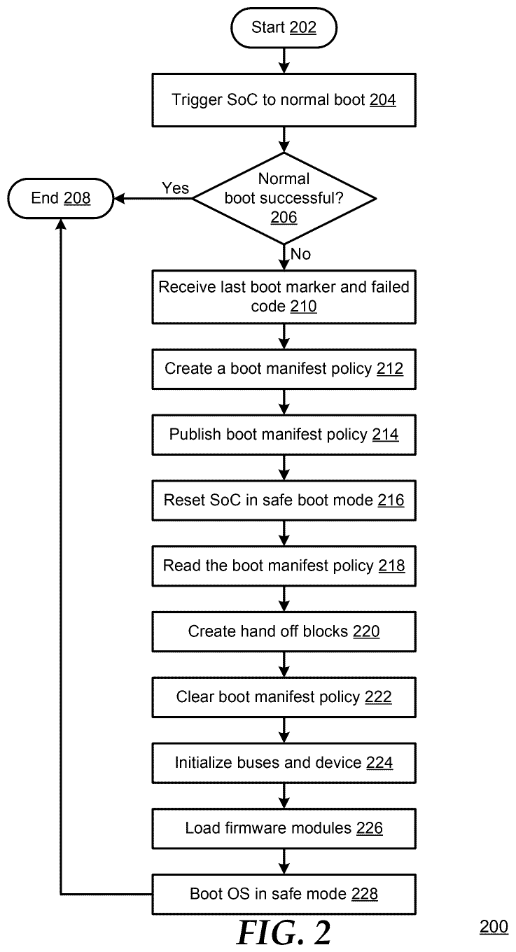

FIG. 2 shows a method 200 for recovering from a boot failure with a dynamic boot manifest policy according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 102 of information handling system 100 in FIG. 1, SoC 104 of information handling system 100 in FIG. 1, or any other type of controller, device, module, processor, or any combination thereof, operable to employ all, or portions of, the method of FIG. 2.

At block 204, a SoC is triggered to normal boot operations. The normal boot operations may be performed or executed based on a default boot policy in the information handling system. In an example, the normal boot operations may include different critical stages or phases. every critical stage of the POST flow or process. These critical stages of the POST boot operations may be any stages of the POST, SEC, pre-PEI, DXE, and BDS. In certain examples, different boot markers may indicate the completion of the different phases or stages in the boot operations. These boot markers may be logged during the boot operations.

At block 206, a determination is made whether the normal boot operations are successful. In response to the normal boot operations being successful, the flow ends at block 208. In response to the normal boot operations not being successful, a last boot marker and failed code are received at block 210.

At block 212, a boot manifest policy is created. In an example, the boot manifest policy may be created or generated based on any suitable data collected during the normal boot operations. For example, the embedded controller may utilize the received last boot marker and failed code to create the boot manifest policy. In certain examples, the boot manifest policy may identify one or more components to remove from the boot operations of the SoC. These components may include, but are not limited to, buses, devices, and firmware modules of the information handling system.

At block 214, the boot manifest policy is published. In an example, the boot manifest policy may be published to the SoC in any suitable manner. For example, the boot manifest policy may be published via a MMIO read only mode configured between the embedded controller and the SoC.

At block 216, the SoC is reset in a safe boot mode. This safe boot mode may include booting only essential system components. At block 218, the boot manifest policy is read. In an example, a manifest reader firmware service of the SoC may read the boot manifest policy during a phase of the boot operations, such as during PEI phase.

At block 220, hand off blocks (HOBs) are created. The HOBs may be created in the PEI phase and may be created based on the boot manifest policy. In an example, the HOBs may include a bus list, a device list, a firmware module list, a boot path and configuration, or the like. These lists, the boot path, and the configuration within the HOBs for the boot operations may be created based on the boot manifest policy.

At block 222, the boot manifest policy is cleared. A firmware service of SoC may clear the boot manifest policy in any suitable manner. For example, a SBIOS of the SoC may provide a clear boot manifest policy request to the embedded controller. In response to receiving the request, the embedded controller may delete the boot manifest policy from the associated storage.

At block 224, buses and devices are initialized. The buses may be initialized based on the buses list created in the HOBs of the PEI boot phase. For example, the only buses initialized are those located within the buses list. In certain examples, the buses included in the boot manifest policy are those buses initialized during the DXE phase of the boot operations. The devices may be initialized based on the devices list created in the HOBs of the PEI boot phase. For example, the only devices initialized are those located within the devices list. In certain examples, the devices included in the boot manifest policy are those devices initialized during the DXE phase of the boot operations.

At block 226, firmware modules are loaded. The firmware modules may be loaded based on the firmware module list created in the HOBs of the PEI boot phase. For example, the only firmware modules loaded are those located within the firmware modules list. In certain examples, the firmware modules included in the boot manifest policy are those firmware modules loaded during the DXE phase of the boot operations. After the firmware modules are loaded, corresponding firmware services are started.

At block 228, the OS is booted in a safe mode and the flow ends at block 208. In an example, the SBIOS of SoC may boot with the new policy may boot the OS in a safe mode or any equivalent mode. The booting of the OS to the safe mode may be based on those components identified in the boot manifest policy. Thus, based on the boot manifest policy, the OS may be booted to a known state.

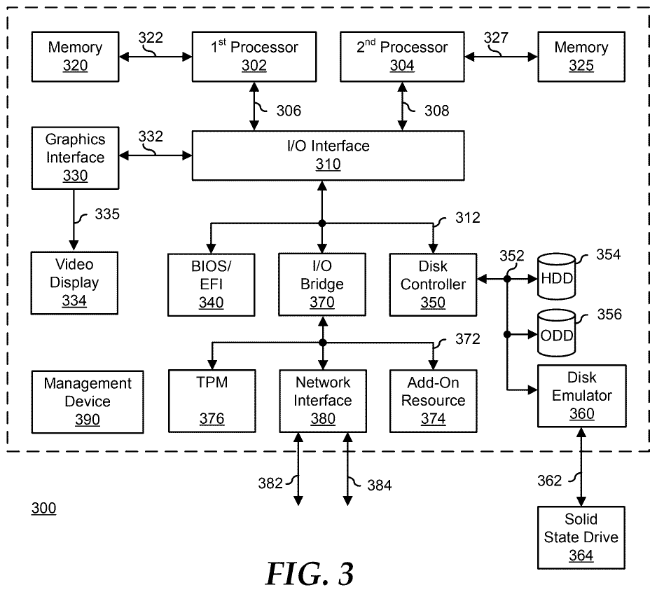

FIG. 3 shows a generalized embodiment of an information handling system 300 according to an embodiment of the present disclosure. Information handling system 300 may be substantially similar to information handling system 100 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An information handling system comprising:
a system on a chip (SoC) to:
execute normal boot operations in the information handling system; and
provide boot markers associated with the normal boot operations; and
an embedded controller to communicate with the SoC, during boot operations of the information handling system, the embedded controller to:
monitor the normal boot operations being executed by the SoC;
store the boot markers received from the SoC;
based on the boot markers, determine whether a boot failure has occurred;
in response to the boot failure, generate a boot manifest policy, wherein the boot manifest policy removes failed components of the normal boot operations from new boot operations;
store the boot manifest policy in a storage associated with the embedded controller;
in response to the boot manifest policy being stored, reset the SoC;
execute safe boot operations; and
during the safe boot operations:
retrieve the boot manifest policy from the storage; and
create handoff blocks based on the boot manifest policy.

2. The information handling system of claim 1, wherein the embedded controller is further configured to: receive an error code with the boot markers, wherein a combination of the boot markers and the error code identify the failed components.

3. The information handling system of claim 1, wherein the embedded controller further to: create a devices list in the handoff blocks, wherein the devices list includes a plurality of devices to be initialized.

4. The information handling system of claim 3, wherein in response to the reset, the SoC further to: load a plurality of firmware modules based on a firmware module list created in the handoff blocks.

5. The information handling system of claim 1, wherein in response to the creating of the handoffs blocks based on the boot manifest policy, the SoC further to: provide a clear boot manifest policy request to the embedded controller.

6. The information handling system of claim 1, wherein the SoC further to: recover the information handling system from a no post-no video state based on an implementation of the boot manifest policy.

7. The information handling system of claim 1, wherein during subsequent boot operation, the SoC further to: boot an operating system of the information handling system to a safe mode known state based on the boot manifest policy.

8. The information handling system of claim 1, wherein the execution of the normal boot operations is based on a default boot policy.

9. A method comprising:
executing, by a system on a chip (SoC) of information handling system, normal boot operations in the information handling system;
providing, by the SoC, boot markers associated with the normal boot operations;
monitoring, by an embedded controller of the information handling system, the normal boot operations being executed by the SoC;
storing the boot markers received from the SoC;
based on the boot markers, determining whether a boot failure has occurred;
in response to the boot failure, generating, by the embedded controller, a boot manifest policy, wherein the boot manifest policy removes failed components of the normal boot operations from new boot operations;
storing the boot manifest policy in a storage associated with the embedded controller;
in response to the boot manifest policy being stored, resetting the SoC;
executing safe boot operations; and
during the safe boot operations:
retrieving the boot manifest policy from the storage; and
creating handoff blocks based on the boot manifest policy.

10. The method of claim 9, further comprising: receiving an error code with the boot markers, wherein a combination of the boot markers and the error code identify the failed components.

11. The method of claim 9, further comprising: creating a devices list in the handoff blocks, wherein the devices list includes a plurality of devices to be initialized.

12. The method of claim 11, further comprising: loading a plurality of firmware modules based on a firmware module list created in the handoff blocks.

13. The method of claim 9, wherein in response to the creating of the handoffs blocks based on the boot manifest policy, the method further comprises: providing a clear boot manifest policy request to the embedded controller.

14. The method of claim 9, further comprising: recovering the information handling system from a no post-no video state based on an implementation of the boot manifest policy.

15. The method of claim 9, wherein during subsequent boot operation, the method further comprises: booting an operating system of the information handling system to a safe mode known state based on the boot manifest policy.

16. The method of claim 9, wherein the executing of the normal boot operations is based on a default boot policy.

17. A method comprising:
executing, by a system on a chip (SoC) of information handling system, normal boot operations in the information handling system, wherein the normal boot operations are based on a default boot policy for the information handling system;
providing, by the SoC, a boot marker and an error code associated with the normal boot operations;
monitoring, by an embedded controller of the information handling system, the normal boot operations being executed by the SoC;
storing the boot marker and the error code received from the SoC;
based on the boot marker and the error code, determining whether a boot failure has occurred;
in response to the boot failure, generating, by the embedded controller, a boot manifest policy, wherein the boot manifest policy removes failed components from the default boot policy;
executing safe boot operations; and
during the safe boot operations:
retrieving the boot manifest policy; and
creating handoff blocks based on the boot manifest policy.

18. The method of claim 17, further comprising: recovering the information handling system from a no post-no video state based on an implementation of the boot manifest policy.

19. The method of claim 17, wherein during subsequent boot operation, the method further comprises: booting an operating system of the information handling system to a safe mode known state based on the boot manifest policy.

20. The method of claim 17, wherein in response to the creating of the handoffs blocks based on the boot manifest policy, the method further comprises: providing a clear boot manifest policy request to the embedded controller.
